(19) United States
(12) Patent Application Publication
(10) Pub. No.: US 2022/0198762 A1
(43) Pub. Date: Jun. 23, 2022

(54) DISPLAY SYSTEM, DISPLAY DEVICE, AND PROGRAM

(71) Applicant: TOYOTA JIDOSHA KABUSHIKI KAISHA, Toyota-shi (JP)

(72) Inventors: Kazuki KOMORIYA, Toyota-shi (JP); Kazumi SERIZAWA, Toyota-shi (JP); Sayaka ISHIKAWA, Miyoshi-shi (JP); Shunsuke TANIMORI, Nagoya-shi (JP); Masaya MIURA, Toyota-shi (JP); Kouji TAMURA, Tokyo (JP); Seiei HIBINO, Nagakute-shi (JP); Rina MUKAI, Toyota-shi (JP); Tomoya INAGAKI, Miyoshi-shi (JP); Chinli DI, Nagoya-shi (JP)

(73) Assignee: TOYOTA JIDOSHA KABUSHIKI KAISHA, Toyota-shi (JP)

(21) Appl. No.: 17/554,108

(22) Filed: Dec. 17, 2021

(30) Foreign Application Priority Data
Dec. 21, 2020 (JP) 2020-211047

(51) Int. Cl. G06T 19/00; G06V 10/70; G06T 7/70

(52) U.S. Cl. CPC G06T 19/006; G06T 7/70; G06V 10/70

(57) ABSTRACT

A display system includes a display device and a server. The display includes an imager, an image recognition unit that recognizes an identifier provided to a portable product and included in the image captured by the imager, a display control unit that generates an augmented reality image in which an image of a virtual object is superimposed on scenery of real world including the portable product in response to recognition of the identifier, a display unit that displays the augmented reality image, and a position information acquisition unit that acquires current position information. The server includes a first storage unit in which a plurality of types of image data of the virtual object is stored, and a first extraction unit that extracts, from the first storage unit, the image data of the virtual object that is provided to the display device, based on the position information of the display device.

### CROSS-REFERENCE TO RELATED APPLICATION

This application claims priority to Japanese Patent Application No. 2020-211047 filed on Dec. 21, 2020, incorporated herein by reference in its entirety.

### BACKGROUND

### 1. Technical Field

The present specification discloses a display system, a display device, and a program for displaying an augmented reality (AR) image.

### 2. Description of Related Art

A display device using augmented reality technology has been known. For example, in Japanese Unexamined Patent Application Publication (Translation of PCT Application) No. 2016-522485 (JP 2016-522485 A), an augmented reality image in which a real object such as an action figure that is a toy is replaced with a virtual object such as a virtual action figure with animation is displayed.

### SUMMARY

The present specification discloses a display system, a display device, and a program capable of improving the added value of a product such as a toy compared with the known product, in providing an augmented reality image display service for the product.

The present specification discloses a display system including a display device and a server. The display device includes an imager, an image recognition unit, a display control unit, a display unit, and a position information acquisition unit. The imager is configured to capture an image of a real world. The image recognition unit is configured to recognize an identifier provided to a product that is portable and included in the image captured by the imager. The display control unit generates an augmented reality image in which an image of a virtual object is superimposed on scenery of the real world including the product in response to recognition of the identifier. The display unit displays the augmented reality image. The position information acquisition unit acquires current position information. The server includes a first storage unit and a first extraction unit. In the first storage unit, a plurality of types of image data of the virtual object is stored. The first extraction unit extracts, from the first storage unit, the image data of the virtual object that is provided to the display device, based on the position information of the display device that is acquired by the position information acquisition unit.

According to the above configuration, when the virtual object image is superimposed on the product, the virtual object image based on the position information is provided. With this, the virtual object image that matches the scenery of a place of stay can be superimposed on the product, which enables improvement of the added value of the product as compared with the known products.

In the above configuration, the display control unit may suspend display of the augmented reality image on the display unit until the identifier has been recognized by the image recognition unit for a predetermined period.

According to the above configuration, it is possible to suppress generation of an augmented reality image due to an unintended reflection of the product.

In the above configuration, the server may include a second storage unit and a second extraction unit. In the second storage unit, the image data of the virtual object that is set corresponding to the identifier is stored. The second extraction unit extracts, from the second storage unit, the image data of the virtual object that is provided to the display device, based on the identifier recognized by the image recognition unit.

According to the above configuration, in addition to the virtual object based on the position information, the virtual object based on the identifier, that is, the virtual object set for the product can be displayed in the augmented reality image. This makes it possible to display, for example, a 3D image of a character provided to the product in accordance with the identifier, and further display a decoration image related to a theme park where a user is staying based on the position information. As a result, it is possible to produce an effect that matches the location, for example, displaying an augmented reality image in which the character is riding a ball in an amusement park.

In the above configuration, the first extraction unit may extract, from the first storage unit, the image data of the virtual object based on a list of the image data of the virtual object that is stored in the first storage unit and that is prohibited from being combined with the image data of a predetermined virtual object that is stored in the second storage unit.

According to the above configuration, it is possible to eliminate decoration images that are not socially appropriate to be combined with characters, and for example, it is possible to suppress generation of an image in which a penguin is jumping through a ring of fire, for example.

The present specification also discloses a display device. The display device includes an imager, an image recognition unit, a display control unit, a display unit, a position information acquisition unit, a storage unit, and an extraction unit. The imager is configured to capture an image of a real world. The image recognition unit is configured to recognize an identifier provided to a product that is portable and included in the image captured by the imager. The display control unit generates an augmented reality image in which an image of a virtual object is superimposed on scenery of the real world including the product in response to recognition of the identifier. The display unit displays the augmented reality image. The position information acquisition unit acquires current position information. In the storage unit, a plurality of types of image data of the virtual object is stored. The extraction unit extracts, from the storage unit, the image data of the virtual object that is superimposed on scenery of the real world, based on the current position information acquired by the position information acquisition unit.

The present specification also discloses a program for causing a computer to function as an imager, an image recognition unit, a display control unit, a display unit, a position information acquisition unit, a storage unit, and an extraction unit. The imager is configured to capture an image of a real world. The image recognition unit is configured to recognize an identifier provided to a product that is portable and included in the image captured by the imager. The display control unit generates an augmented reality image in which an image of a virtual object is superimposed on scenery of the real world including the product in response to recognition of the identifier. The display unit displays the augmented reality image. The position information acquisition unit acquires current position information. In the storage unit, a plurality of types of image data of the virtual object is stored. The extraction unit extracts, from the storage unit, the image data of the virtual object that is superimposed on scenery of the real world, based on the current position information acquired by the position information acquisition unit.

With the display system, the display device, and the program disclosed in the present specification, it is possible to improve the added value of a product such as a toy as compared with the known product, in providing an augmented reality image display service for the product.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a complex entertainment facility including a display system according to the present embodiment;

FIG. 2 is a perspective view illustrating a product provided with an AR marker as an identifier;

FIG. 3 is a diagram illustrating hardware configurations of a display device and a server of the display system according to the present embodiment;

FIG. 4 is a diagram illustrating functional blocks of the server;

FIG. 5 is a diagram illustrating functional blocks of the display device;

FIG. 6 is a diagram illustrating an augmented reality image displayed when the display device is located in a zoo;

FIG. 7 is a diagram illustrating an augmented reality image displayed when the display device is located in an aquarium;

FIG. 8 is a diagram illustrating an outline of camera position-posture estimation;

FIG. 9 is a diagram illustrating an augmented reality image display flow;

FIG. 10 is a diagram illustrating a head-mounted display (HMD) as an example of the display device; and

FIG. 11 is a functional block diagram showing an example of the display device including a server function.

### DETAILED DESCRIPTION OF EMBODIMENTS

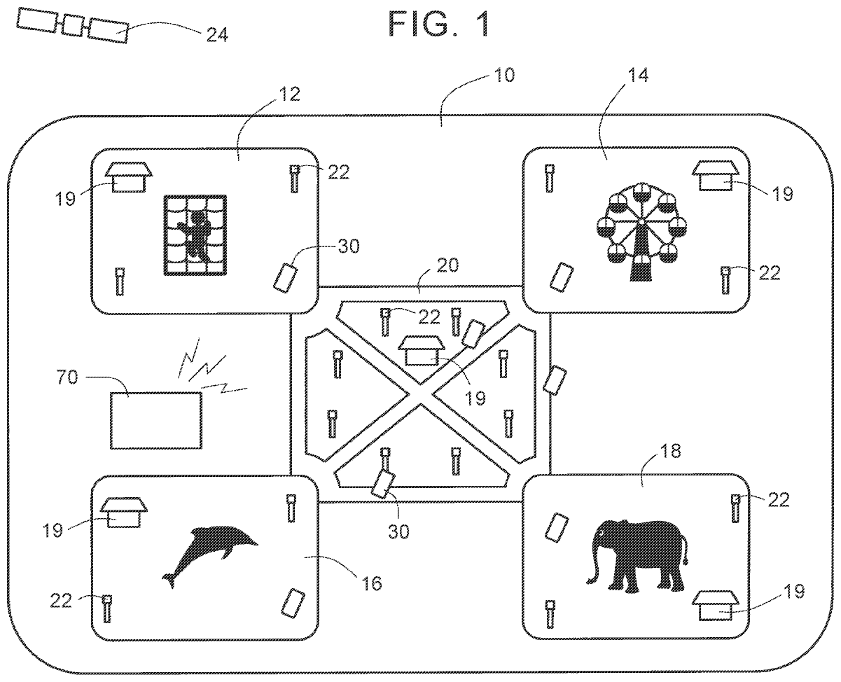

FIG. 1 illustrates a complex entertainment facility 10. In this facility, a display system according to the present embodiment is used. As will be described later, the display system according to the present embodiment includes an augmented reality (AR) display device 30 and a server 70.

Configuration of Complex Entertainment Facility

The complex entertainment facility 10 includes a plurality of theme parks 12 to 18. The theme park refers to a facility having a concept based on a specific theme (subject) and including facilities, events, scenery, and the like that are comprehensively organized and produced based on that concept. For example, the theme parks 12 to 18 are connected by a connecting passage 20, and users can come and go between the theme parks 12 to 18 through the connecting passage 20.

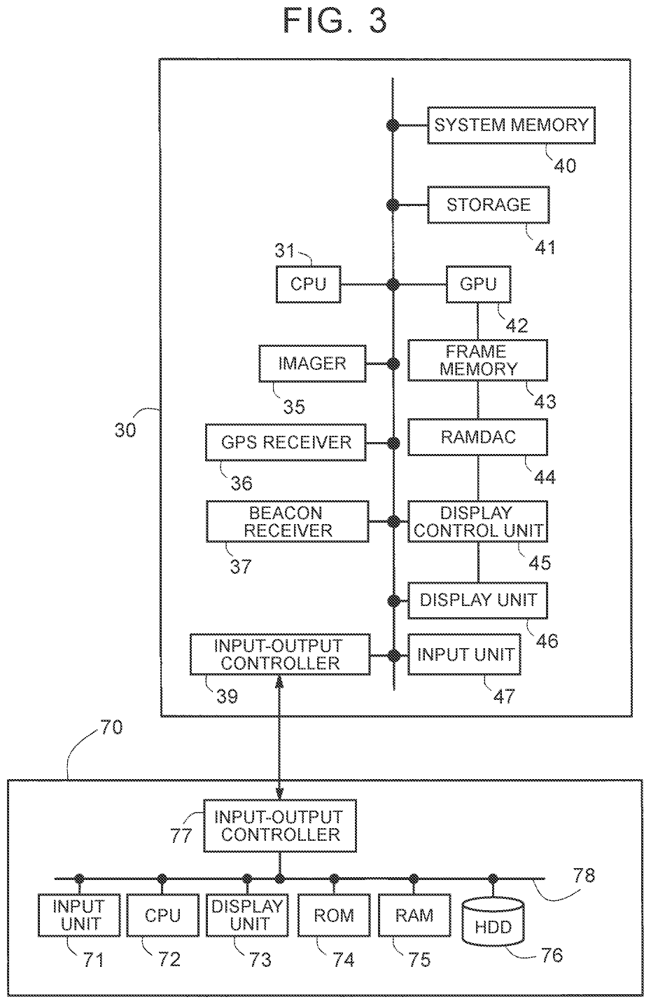

A beacon transmitter 22 is provided in the theme parks 12 to 18 and the connecting passage 20. A plurality of transmitters 22 are provided, for example, at equal intervals. As will be described later, when a beacon receiver 37 (see FIG. 3) of the AR display device 30 receives a signal from the transmitter 22, the current position of the AR display device 30 can be acquired.

The complex entertainment facility 10 includes theme parks having different themes. For example, the complex entertainment facility 10 includes an athletic park 12, an amusement park 14, an aquarium 16, and a zoo 18 as the theme parks.

Characters are set for each of the theme parks 12 to 18 based on their respective themes. The characters are set so as to match the theme and the concept of each of the theme parks 12 to 18. For example, for the athletic park 12, characters such as an adventurer, a ranger, and a ninja are set. For example, for the amusement park 14, characters such as a clown and a go-kart are set. For example, for the aquarium 16, characters such as a dolphin, goldfish, and a shark are set. Further, for example, for the zoo 18, characters such as an elephant, a panda, and a penguin are set.

The complex entertainment facility 10 also includes shops 19. For example, the shop 19 is set up along the connecting passage 20. The shop 19 may also be set up in each of the theme parks 12 to 18. Products based on the theme of each of the theme parks 12 to 18 are sold at the shop 19.

Configuration of Products

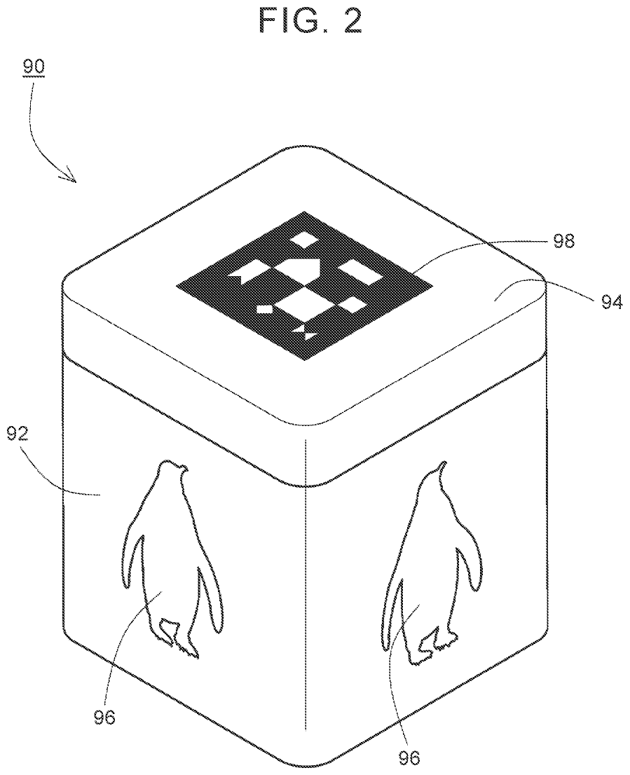

FIG. 2 illustrates a product 90 sold at the shop 19. The product 90 is, for example, a souvenir that is purchased to commemorate the visit to the theme parks 12 to 18. For example, the product 90 illustrated in FIG. 2 is a generally cubic cookie can.

The surfaces of the product 90 are provided with pictures showing which of the theme parks 12 to 18 the product 90 is associated with. For example, pictures 96 of a character set based on the theme of each of the theme parks 12 to 18 are printed on the surfaces of the product 90. For example, in FIG. 2, the character pictures 96 of a penguin are printed on the side surfaces of the cookie can that is the product 90 to commemorate the visit to the zoo 18.

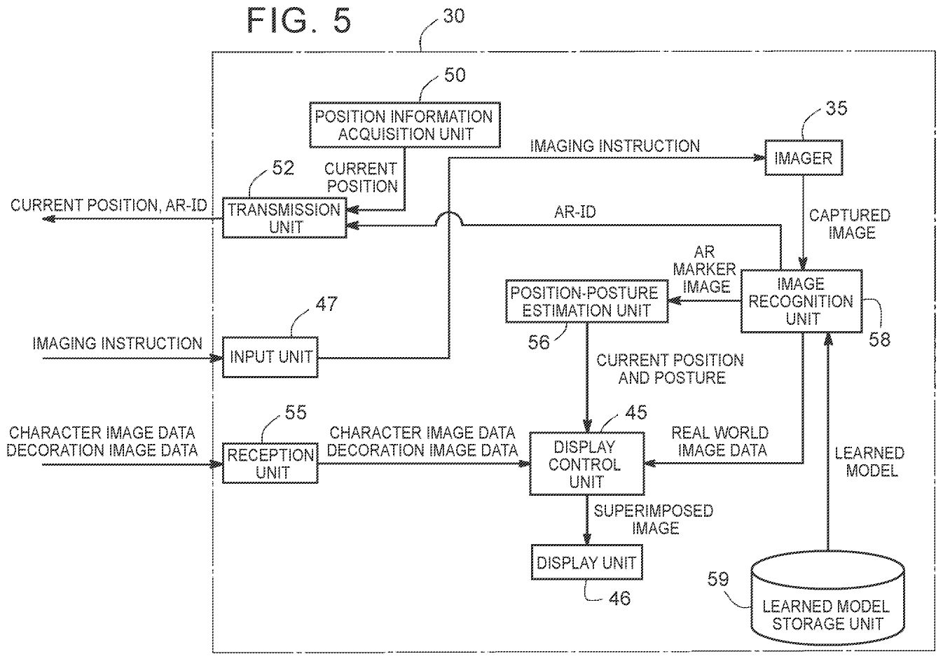

In addition to the character pictures 96, an identifier for displaying an augmented reality image is provided on the surface of the product 90. For example, in FIG. 2, an AR marker 98 that is an identifier is printed on the top surface of a lid 94 of the product 90. The AR marker 98 is defined by, for example, two colors including black and white, in order to facilitate decoding by an imager 35 (see FIG. 5). The AR marker 98 is printed so as to have a pattern that is asymmetrical in the vertical and horizontal directions in a plan view in order to determine the direction. Further, the AR marker 98 has a rectangular shape such that the planar shape and the inclination angle can be easily estimated, and is printed so as to be a square in a plan view, for example. The flow from image recognition of the AR marker 98 to the display of the augmented reality image will be described later.

The product 90 is portable and can be placed anywhere in the complex entertainment facility 10. For example, a purchaser can carry the product 90 purchased at the shop 19 in the zoo 18 to the amusement park 14. As will be described later, in the display system according to the present embodiment, an augmented reality image corresponding to the place where the product 90 is placed is displayed.

Configuration of Server

FIG. 3 illustrates hardware configurations of the AR display device 30 and the server 70 that constitute the display system according to the present embodiment. The server 70 is composed of, for example, a computer, and is installed in, for example, a management building of the complex entertainment facility 10 (see FIG. 1). The server 70 is wirelessly connected to the AR display device 30 by communication means such as a wireless local area network (LAN).

The server 70 includes an input unit 71 such as a keyboard and a mouse, a central processing unit (CPU) 72 serving as an arithmetic device, and a display unit 73 such as a display. The server 70 also includes a read-only memory (ROM) 74, a random access memory (RAM) 75, and a hard disk drive (HDD) 76 as storage devices. Further, the server 70 includes an input-output controller 77 that manages input and output of information. These components are connected to an internal bus 78.

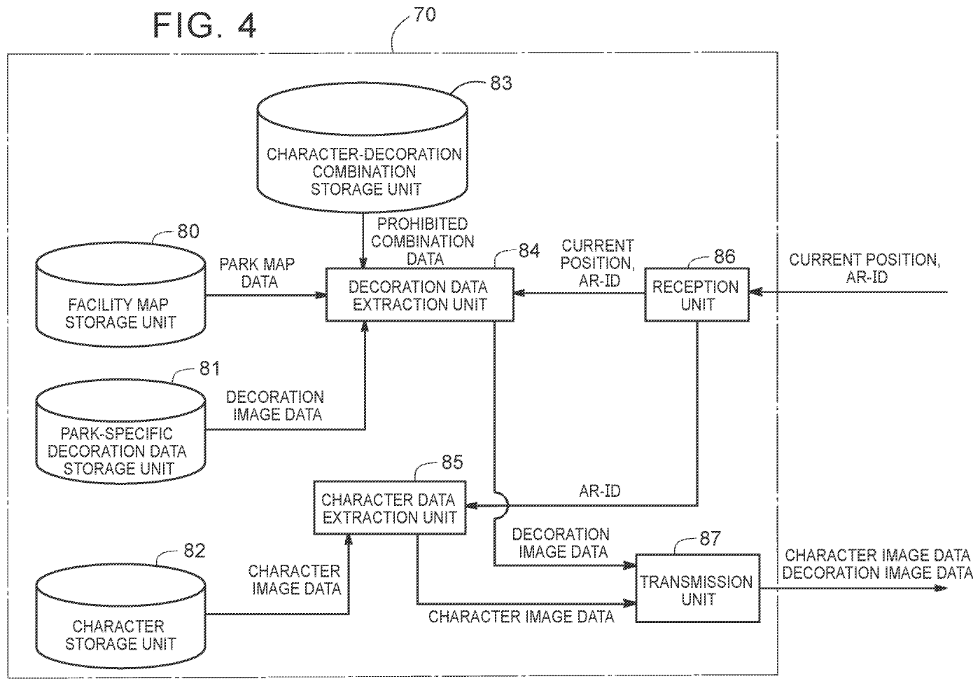

FIG. 4 illustrates functional blocks of the server 70. The functional block diagram is configured such that the CPU 72 executes a program stored in, for example, the ROM 74 or the HDD 76 or stored in a computer readable non-transitory storage medium such as a digital versatile disc (DVD).

The server 70 includes a facility map storage unit 80, a park-specific decoration data storage unit 81 (first storage unit), a character storage unit 82 (second storage unit), and a character-decoration combination storage unit 83 as storage units. The server 70 also includes a decoration data extraction unit 84, a character data extraction unit 85, a reception unit 86, and a transmission unit 87.

The facility map storage unit 80 stores map information of the complex entertainment facility 10. For example, position information of passages and facilities in the complex entertainment facility 10 is stored.

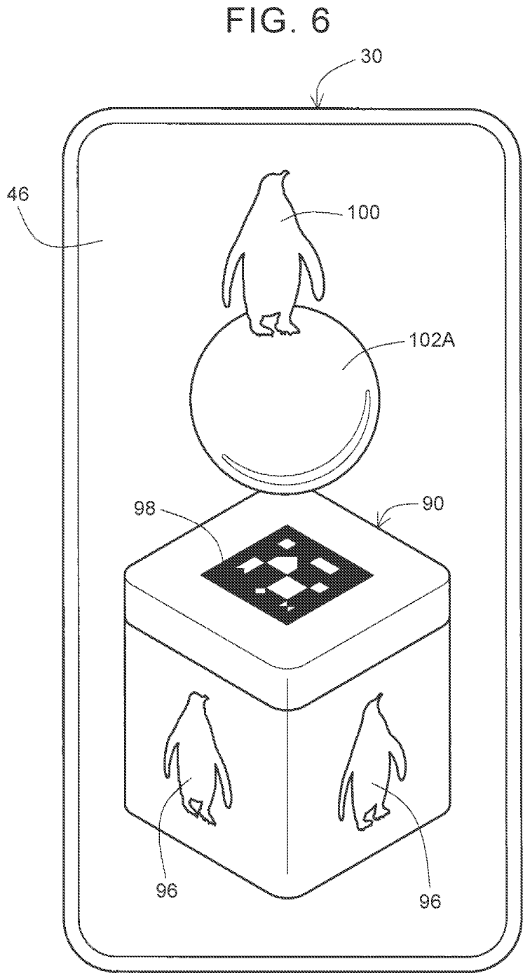

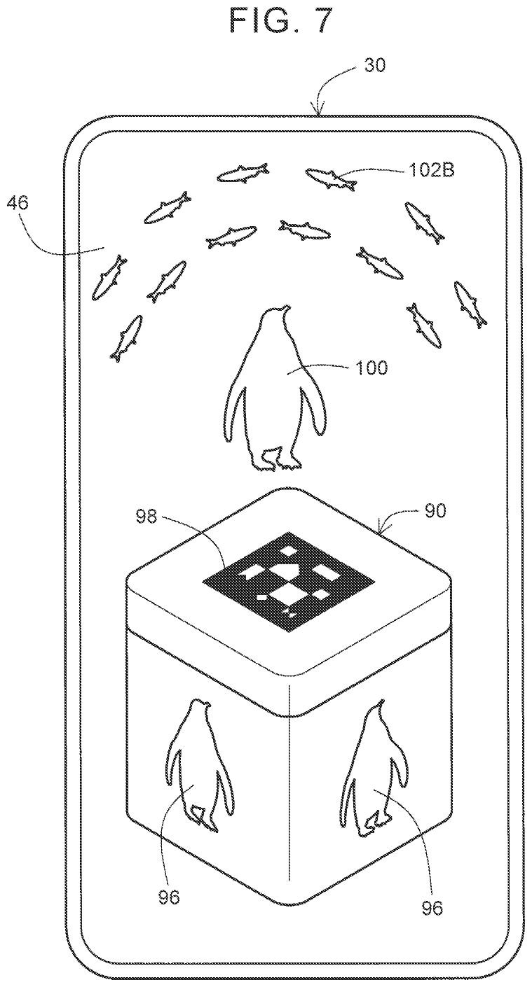

The park-specific decoration data storage unit 81 (first storage unit) stores image data of a decoration object that is a virtual object, among the augmented reality images that are displayed on the AR display device 30. The decoration object refers to, for example, a large ball 102A as shown in FIG. 6 or a school of fish 102B in FIG. 7, and includes a virtual object that is displayed on the AR display device 30 as a decoration of the character image 100.

The image data of the decoration object stored in the park-specific decoration data storage unit 81, that is, the decoration image data may be 3D model data of the decoration object that is a virtual object. The 3D model data includes, for example, 3D image data of the decoration object, and the 3D image data includes shape data, texture data, and motion data.

A plurality of types of decoration image data is stored for each of the theme parks 12 to 18. For example, 10 to 100 types of decoration image data are stored for one theme park. The decoration image data is individually provided with an identification code of a corresponding theme park, out of the theme parks 12 to 18. Further, a unique identification code is provided to each piece of the decoration image data.

The decoration image data includes images related to the theme parks 12 to 18, to which the identification codes are provided. For example, as shown in FIG. 6, the decoration image 102A with the identification code corresponding to the amusement park 14 is an image of a large ball for ball riding. Also, for example, as shown in FIG. 7, the decoration image 102B with the identification code corresponding to the aquarium 16 is an image of an arch made of a school of fish.

In FIGS. 6 and 7, contour drawings are shown as the decoration images and the character images in order to clarify the illustration, but the present disclosure is not limited to this form. The 3D images of the decoration images and the character images may be displayed. Hereinafter, as appropriate, the 3D images of the character and the decoration object are simply referred to as the character image and the decoration image.

With reference to FIG. 4, the character storage unit 82 (second storage unit) stores information on the characters that are virtual objects set for each of the theme parks 12 to 18. The information on the characters may be, for example, 3D model data of each character. The 3D model data includes, for example, 3D image data of a character, and the 3D image data includes shape data, texture data, and motion data.

The 3D model data of each character is stored in the character storage unit 82 in association with the identification code (AR-ID) obtained by decoding the identifier provided to the product 90. For example, as will be described later, the AR marker 98 that is the identifier provided to the product 90 (see FIG. 2) is recognized by the image recognition unit 58 (see FIG. 5) and decoded into the AR-ID. Further, the virtual object corresponding to the AR-ID, that is, the 3D model data of the character is extracted from the character storage unit 82.

The character-decoration combination storage unit 83 stores a list of decoration images that are prohibited from being combined with the character images (hereinafter, appropriately referred to as a combination prohibition list). The list lists combinations that are not socially appropriate, such as a case in which the character image is a penguin and the decoration image shows jumping through a ring of fire. For example, the list is set in advance by the manager of the complex entertainment facility 10 or the like. As the format of the list, for example, the AR-ID of the character image and the identification code (ID) of the decoration image that is prohibited from being combined with the character image are associated with each other and stored.

The reception unit 86 receives signals from an external device such as the AR display device 30. From the AR display device 30, the current position information of the AR display device 30 and the AR-ID information of the product 90 imaged by the AR display device 30 are transmitted to the reception unit 86. The decoration data extraction unit 84 (first extraction unit) determines which of the theme parks 12 to 18 the AR display device 30 is located in, based on the current position information acquired by a position information acquisition unit 50 (see FIG. 5). Further, the decoration data extraction unit 84 extracts the decoration image data set corresponding to the theme park, out of the theme parks 12 to 18, in which the AR display device is located, from the park-specific decoration data storage unit 81.

The character data extraction unit 85 (second extraction unit) extracts the image data of the character that is the virtual object corresponding to the received AR-ID, from the character storage unit 82. The extracted decoration image data and character image data are transmitted to the AR display device 30 via the transmission unit 87.

Configuration of AR Display Device

With reference to FIG. 1, the AR display device 30 is a display device used by a user of the complex entertainment facility 10. The AR display device 30 can display a virtual reality image in which an image of a virtual object is superimposed on scenery of the real world.

The AR display device 30 may be a portable device and is movable with the product 90. For example, the AR display device 30 is a smartphone provided with an imaging device and a display unit, or a glasses-type head-mounted display (HMD).

The AR display device 30 can be divided into a video see-through display (VST display) and an optical see-through display (OST display) from a viewpoint of the mode of displaying scenery of the real world. In the VST display, an imager such as a camera captures an image of scenery of the real world, and the captured image is displayed on the display. On the other hand, in the OST display, scenery of the real world is visually recognized through a transmissive display unit such as a half mirror, and a virtual object is projected onto the display unit.

The AR display device 30 provided with an imager 35 (see FIG. 3), such as the smartphone mentioned above, is classified as the VST display. The head-mounted display (HMD) mentioned above is classified as the OST display because the scenery of the real world is visually recognized with the lenses of eyeglasses used as the display unit.

In the embodiment below, as shown in FIG. 6, a VST display-type smartphone is illustrated as an example of the AR display device 30. This smartphone may be property of the user of the complex entertainment facility 10, or may be a leased item such as a tablet terminal to be lent to the user of the complex entertainment facility 10.

FIG. 3 illustrates a hardware configuration of the AR display device 30 together with a hardware configuration of the server 70. The AR display device 30 includes a central processing unit (CPU) 31, the imager 35, a Global Positioning System (GPS) receiver 36, the beacon receiver 37, the input-output controller 39, a system memory 40, a storage 41, a graphics processing unit (GPU) 42, a frame memory 43, a RAM digital-to-analog converter (RAMDAC) 44, a display control unit 45, a display unit 46, and an input unit 47.

The system memory 40 is a storage device used by an operating system (OS) executed by the CPU 31. The storage 41 is an external storage device, and stores, for example, a program for displaying a virtual reality image (AR image), which will be described later.

The imager 35 is, for example, a camera device mounted on a smartphone, and can capture an image of the scenery of the real world as a still image or a moving image. The imager 35 includes an imaging device such as a complementary metal oxide semiconductor (CMOS) imaging device or a charge coupled device (CCD) imaging device. Further, the imager 35 may be a so-called RGB-D camera having a function of measuring the distance from the imager 35 in addition to a function of imaging the real world. As the function of measuring the distance, for example, the imager 35 is provided with a distance measuring mechanism using infrared rays, in addition to the above-mentioned imaging device.

The GPU 42 is an arithmetic device for image processing, and is mainly operated when image recognition described later is performed. The frame memory 43 is a storage device that stores an image captured by the imager 35 and subjected to computation by the GPU 42. The RAMDAC 44 converts the image data stored in the frame memory 43 into analog signals for the display unit 46 that is an analog display.

The GPS receiver 36 receives GPS signals that are positioning signals from a GPS satellite 24 (see FIG. 1). The GPS signal includes position coordinate information of latitude, longitude, and altitude. The beacon receiver 37 receives position signals from the beacon transmitters 22 installed in the complex entertainment facility 10 including the connecting passage 20.

Here, both the GPS receiver 36 and the beacon receiver 37 have overlapping position estimation functions. Therefore, the AR display device 30 may be provided with only one of the GPS receiver 36 and the beacon receiver 37.

The input unit 47 can input an activation instruction and an imaging instruction to the imager 35. For example, the input unit 47 may be a touch panel integrated with the display unit 46.

The display control unit 45 can generate an augmented reality image (AR image) in which an image of a virtual object is superimposed on scenery of the real world and display the AR image on the display unit 46. As will be described later, display of the augmented reality image is executed when the image recognition unit recognizes the AR marker 98 that is an identifier provided to the product 90 (see FIG. 2).

For example, the display control unit 45 performs image processing (rendering) in which the character image 100 (see FIG. 6) and the decoration image 102A that are the virtual object images are superimposed on the captured image of the real world at a position above the image of the AR marker 98 to generate an augmented reality image. This image is displayed on the display unit 46. The display unit 46 may be, for example, a liquid crystal display or an organic electroluminescence (EL) display.

FIG. 5 illustrates a functional block diagram of the AR display device 30. The functional block diagram is configured such that the CPU 31 or the GPU 42 executes a program stored in, for example, the system memory 40 or the storage 41, or stored in a computer-readable non-transitory storage medium such as a DVD or a hard disk of a computer.

FIG. 5 shows a part of the hardware configuration illustrated in FIG. 3 and the functional blocks in a combined state. FIG. 5 illustrates the imager 35, the display control unit 45, the display unit 46, and the input unit 47 as the hardware configuration.

Further, as the functional blocks, the AR display device 30 includes a position information acquisition unit 50, a transmission unit 52, a reception unit 55, a position-posture estimation unit 56, and an image recognition unit 58. The AR display device 30 includes a learned model storage unit 59 as a storage unit. These functional blocks are composed of the CPU 31, the system memory 40, the storage 41, the GPU 42, the frame memory 43, and the like.

The position information acquisition unit 50 acquires information on the current position of the AR display device 30 from at least one of the GPS receiver 36 and the beacon receiver 37 in FIG. 3. This position information is a so-called world coordinate system, and in the case of GPS signals, latitude, longitude and altitude information is included in the position information. When the received position information is acquired from the beacon signal, the position information includes, for example, the x-coordinate and the y-coordinate of the plane coordinate system with a specified point in the complex entertainment facility 10 set as the origin.

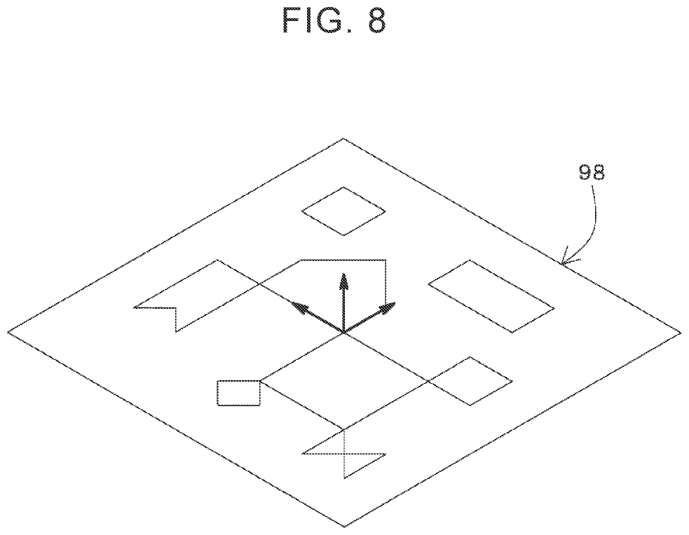

The position-posture estimation unit 56 estimates the so-called camera position and posture. That is, the position and the posture of the imager 35 with respect to the AR marker 98 are estimated. For example, as illustrated in FIG. 8, an image from which the contour line of the AR marker 98 is extracted is transmitted from the image recognition unit 58. This image is acquired by a known image processing technique. For example, the position-posture estimation unit 56 converts the captured image into a black-and-white binary image, and searches for the boundary line of the two colors, that is, the contour line.

The position-posture estimation unit 56 searches for a contour line having a closed shape, and further obtains a corner portion (edge) of the shape to obtain a plane of the AR marker 98. Further, the position-posture estimation unit 56 calculates a camera position and posture based on the known planar projective transformation. As a result, as shown by the arrow in FIG. 8, a Cartesian coordinate system with respect to the plane of the AR marker 98 is obtained. Based on this Cartesian coordinate system, the display angles of the character image 100 and the decoration image 102 (102A, 102B) are determined.

The image recognition unit 58 receives the image data captured by the imager 35 and performs image recognition. The image recognition includes recognition of objects in the captured image and estimation of the distance between each object and the AR display device 30. In such image recognition, the captured image data includes, for example, a color image data obtained by imaging the scenery of the real world as well as distance data of each object in the color image data from the imager 35, as described above.

The image recognition unit 58 recognizes the captured image using the learned model for image recognition stored in the learned model storage unit 59. The learned model storage unit 59 stores, for example, a neural network for image recognition that has been trained by an external server or the like. For example, outdoor image data containing the complex entertainment facility 10, in which each object in the image has been segmented and annotated, is prepared as training data. Using this training data, a multi-level neural network is formed that has machine-learned by supervised learning, and is stored in the learned model storage unit 59. This neural network may be, for example, a convolutional neural network (CNN).

As will be described later, each object in the captured image is defined by segmentation and the distance from each object is obtained, which enables the concealment process based on the front-back relationship as seen from the AR display device 30. For example, it is possible to perform image processing such that when an object passes in front of the product 90, the character image 100 and the decoration image 102 (102A, 102B) that are virtually arranged behind the passing object are concealed behind the passing object.

### Augmented Reality Image Display Flow

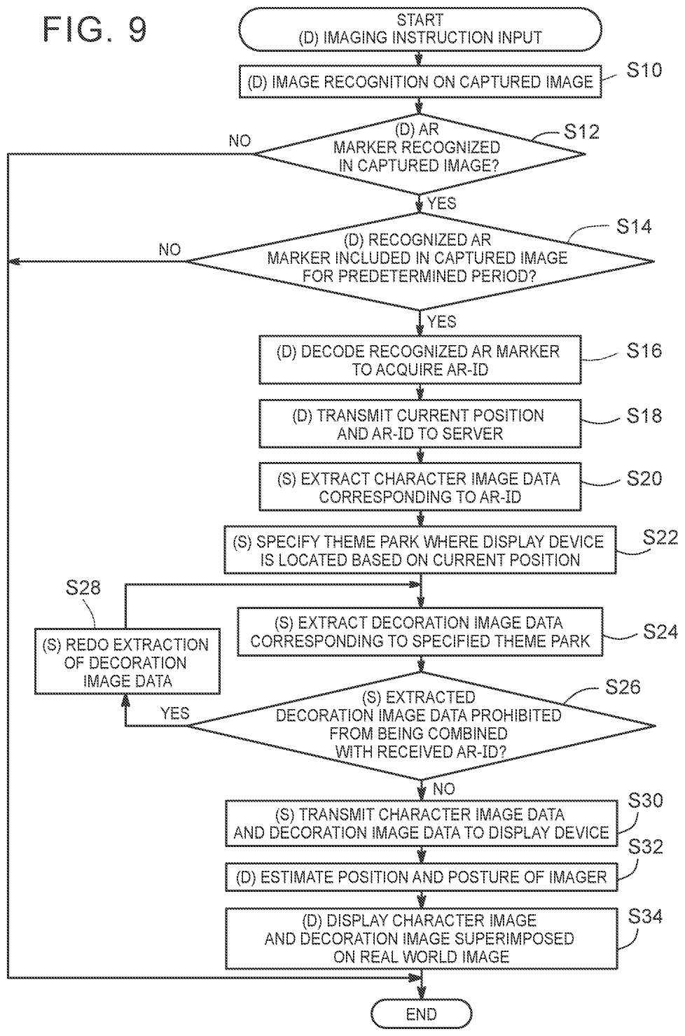

FIG. 9 illustrates an augmented reality image display flow by the display system according to the present embodiment. The display flow is executed when the CPU 31 or the GPU 42 executes a program stored in, for example, the system memory 40 or the storage 41, or stored in a computer-readable non-transitory storage medium such as a DVD or a hard disk of a computer.

In FIG. 9, the steps executed by the AR display device 30 are indicated by (D), and the steps executed by the server 70 are indicated by (S). With reference to FIGS. 4 and 5 in addition to FIG. 9, when the imaging instruction is input from the input unit 47 of the AR display device 30, the flow is activated. The imager 35 transmits the captured image obtained based on the imaging instruction to the image recognition unit 58.

The image recognition unit 58 performs image recognition on the received captured images (S10). The image recognition includes recognition of the product 90 (see FIG. 2) included in the captured image, recognition of the AR marker 98 that is the identifier provided to the product 90, and recognition of each object (real object) in the captured image. The recognition also includes segmentation and annotation. Further, in the image recognition, the distance of each object from the AR display device 30 is obtained.

The image recognition unit 58 determines whether the AR marker 98 is recognized in the captured image (S12). When the AR marker 98 is not recognized, the flow ends. On the other hand, when the AR marker 98 is recognized in the captured image, the image recognition unit 58 tracks the AR marker 98 for a predetermined period (performs so-called marker tracking), and determines whether the AR marker 98 is continuously included in the captured image for the predetermined period (S14). The predetermined period may be, for example, five seconds or more and 10 seconds or less.

When the AR marker 98 disappears from the captured image during the predetermined period, it is considered to be a so-called unintended reflection, and therefore, generation of the augmented reality image activated by the AR marker 98 is not carried out. That is, the display of the augmented reality image on the display unit 46 is suspended. On the other hand, when the AR marker 98 is continuously included in the captured image for the predetermined period, the image recognition unit 58 decodes the AR marker 98 to acquire the AR-ID (S16).

Further, the position information acquisition unit 50 acquires the current position of the AR display device 30. The current position information and the AR-ID are transmitted from the transmission unit 52 to the server 70 (S18). When the reception unit 86 of the server 70 receives the current position information of the AR display device 30 and the AR-ID of the product 90, the AR-ID is transmitted to the character data extraction unit 85. The character data extraction unit 85 extracts the data of the character image 100 (see FIG. 6) corresponding to the received AR-ID, from the character storage unit 82 (S20).

The current position information of the AR display device 30 and the AR-ID of the product 90 are also transmitted to the decoration data extraction unit 84. The decoration data extraction unit 84 obtains a theme park, out of the theme parks 12 to 18, corresponding to the current position information, that is, a theme park including the current position, from the park map data stored in the facility map storage unit 80 (S22). Further, the decoration data extraction unit 84 refers to the park-specific decoration data storage unit 81 to extract the data of the decoration image 102 (102A, 102B) set for the obtained theme park, out of the theme parks 12 to 18 (see FIGS. 6 and 7) (S24). When a plurality of types of decoration image data is stored in the park-specific decoration data storage unit 81 for the obtained theme park, out of the theme parks 12 to 18, for example, the decoration image data is randomly extracted therefrom.

Further, the decoration data extraction unit 84 determines whether the extracted decoration image data is prohibited from being combined with the character image data extracted in step S20 (S26). This determination is made based on the combination prohibition list stored in the character-decoration combination storage unit 83. For example, the decoration data extraction unit 84 determines whether the combination of the AR-ID and the identification code of the extracted decoration image data is registered in the combination prohibition list.

When the extracted decoration image is prohibited from being combined with the extracted character image, the decoration data extraction unit 84 returns to step S24 in order to redo the extraction of the decoration image data (S28).

On the other hand, when the extracted decoration image is not prohibited from being combined with the extracted character image, the decoration data extraction unit 84 transmits the extracted decoration image data to the transmission unit 87. The transmission unit 87 transmits the character image data extracted by the character data extraction unit 85 together with the received decoration image data to the AR display device 30 (S30).

When the reception unit 55 of the AR display device 30 receives the character image data and the decoration image data from the server 70, the data is transmitted to the display control unit 45. Further, the position-posture estimation unit 56 acquires a contour image (see FIG. 8) of the AR marker 98 from the image recognition unit 58 to estimate the camera position and posture as described above (S32).

When the Cartesian coordinate system on the AR marker 98 is obtained through the camera position-posture estimation, the positions and the postures of the character image and the decoration image are determined along the coordinate system. In response to this, the display control unit 45 generates an augmented reality image in which the character image and the decoration image having determined position and posture, that is, the images of the virtual objects are superimposed on the scenery of the real world, and displays the image on the display unit 46 (S34). The display positions of the character image and the decoration image are determined in advance so as to be above, in the screen, the AR marker 98 in the captured image, for example.

As described above, with the display system according to the present embodiment, the decoration image that is a virtual object image is superimposed on the captured image based on the position information of the AR display device 30. In addition, the character image that is a virtual object image is superimposed on the captured image, based on the AR marker 98 that is the identifier provided to the product 90.

With the setting of the decoration image based on the position information, the decoration image varies depending on the theme park that the user is visiting, out of the theme parks 12 to 18, and the decoration image is displayed that matches the concept of the theme park, out of the theme parks 12 to 18, where the user is staying.

Further, the character image is set based on the AR marker 98 and displayed in the augmented reality image together with the decoration image, so that it is possible to produce an effect that the user is going around each of the theme parks 12 to 18 together with the character.

Other Example of AR Display Device

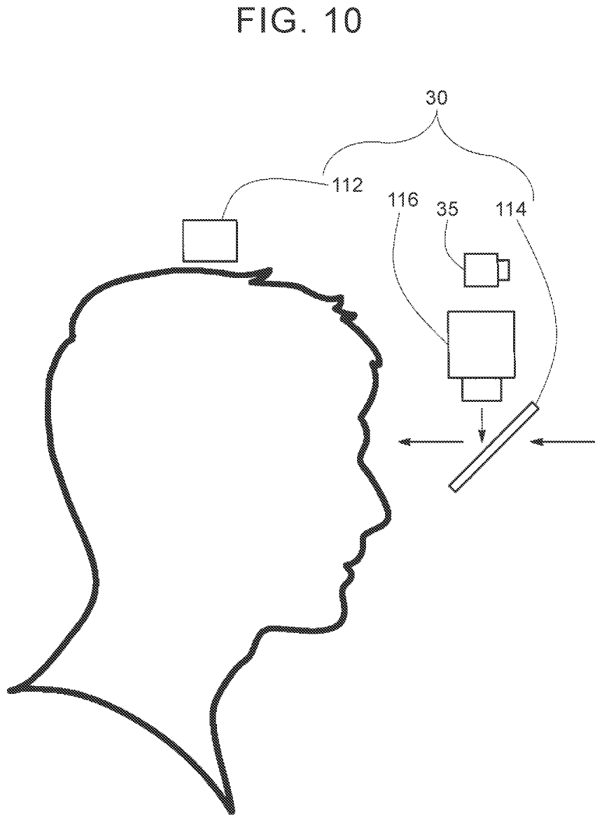

In the above-described embodiment, the AR display device 30 is exemplified by a smartphone that is a video see-through display. However, the AR display device 30 according to the present embodiment is not limited to this form. For example, as is the head-mounted display (HMD) as illustrated in FIG. 10, the AR display device 30 may be composed of an optical see-through display.

In this case, the AR display device 30 includes the imager 35, a half mirror 114 corresponding to the display unit 46, a projector 116 corresponding to the display control unit 45 and the image recognition unit 58, and a sensor unit 112 corresponding to the position information acquisition unit 50 and the position-posture estimation unit 56.

The half mirror 114 may be, for example, the lenses of eyeglasses or goggles. The half mirror 114 allows light (image) from the real world to be transmitted to the user. The projector 116 disposed above the half mirror 114 projects an image of the virtual object onto the half mirror 114. This makes it possible to display an augmented reality image in which a character image and a decoration image that are virtual object images are superimposed on scenery of the real world.

Other Example of AR Display Device

In the above-described embodiment, the augmented reality image display flow of FIG. 9 is executed by the AR display device 30 and the server 70. However, instead of this, the AR display device 30 may execute all the steps of the flow. In this case, the AR display device 30 is composed of, for example, a tablet terminal having a storage capacity larger than that of the smartphone.

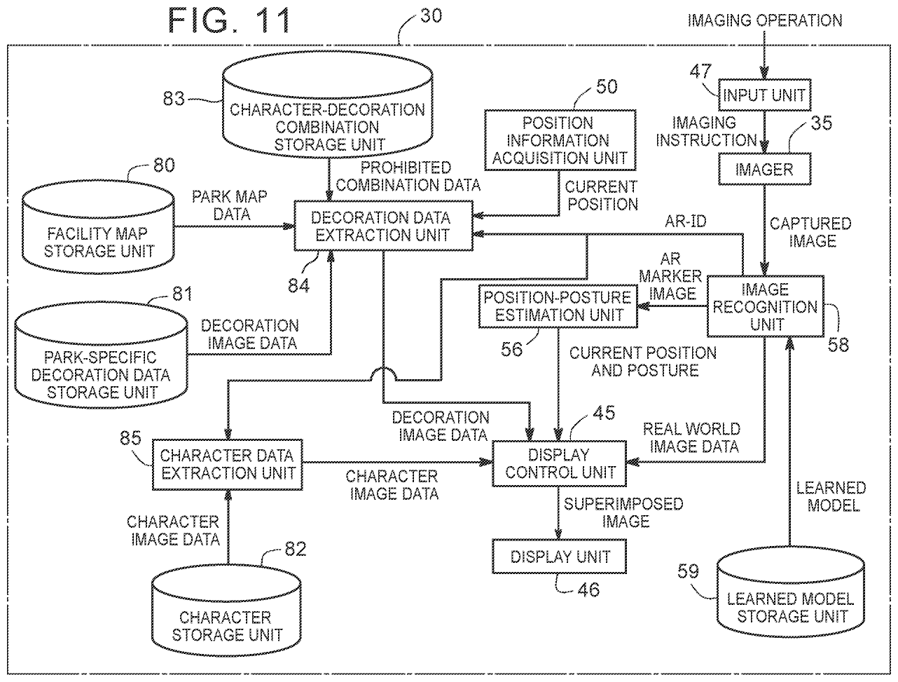

FIG. 11 is a modification of FIG. 5 and illustrates a functional block diagram of the AR display device 30. The functional block diagram is configured such that the CPU 31 or the GPU 42 executes a program stored in, for example, the system memory 40 or the storage 41, or stored in a computer-readable non-transitory storage medium such as a DVD or a hard disk of a computer.

Unlike the AR display device 30 in FIG. 5, the AR display device 30 includes the facility map storage unit 80, the park-specific decoration data storage unit 81 (first storage unit), the character storage unit 82 (second storage unit), and the character-decoration combination storage unit 83. The AR display device 30 also includes the decoration data extraction unit 84 (first extraction unit) and the character data extraction unit 85 (second extraction unit).

The configurations provided in the server 70 in FIGS. 4 and 5 are provided in the AR display device 30, so that the virtual reality image display flow can be executed by the AR display device 30 alone. For example, in the flow of FIG. 9, all the steps are executed by the AR display device 30. Further, since it is not necessary to exchange data between the AR display device 30 and the server 70, steps S18 and S30 are unnecessary.

Other Example of Identifier

In the above-described embodiment, the AR marker 98 is provided to the surface of the product 90 as the identifier for the AR display device 30 to generate an augmented reality image, but the display system according to the present embodiment is not limited to this form. For example, a so-called markerless AR method in which the AR marker 98 is not provided to the product 90 may be adopted.

Specifically, the character picture 96 (see FIG. 2) provided to the surface of the product 90 may be used as the identifier. For example, the flow is configured such that when segmentation and annotation is performed on the captured image by image recognition and the character picture 96 (see FIG. 2) provided to the surfaces of the product 90 is recognized in step S12 of FIG. 9, the process proceeds to step S14. Further, the flow is configured such that when the character picture 96 is continuously included in the captured image for a predetermined period in step S14, the process proceeds to step S16.

Further, in step S16, the image recognition unit 58 may acquire the AR-ID related to the shape (that can be estimated by segmentation) and the attributes (that can be estimated by annotation) of the character picture 96. In this case, the correspondence between the shape and the attributes of the character picture 96 and the AR-ID may be stored in advance in the AR display device 30.

What is claimed is:

1. A display system comprising:
a display device including
an imager configured to capture an image of a real world,
an image recognition unit configured to recognize an identifier provided to a product that is portable and included in the image captured by the imager,
a display control unit that generates an augmented reality image in which an image of a virtual object is superimposed on scenery of the real world including the product in response to recognition of the identifier,
a display unit that displays the augmented reality image, and
a position information acquisition unit that acquires current position information; and
a server including
a first storage unit in which a plurality of types of image data of the virtual object is stored, and
a first extraction unit that extracts, from the first storage unit, the image data of the virtual object that is provided to the display device, based on the position information of the display device that is acquired by the position information acquisition unit.

2. The display system according to claim 1, wherein the display control unit suspends display of the augmented reality image on the display unit until the identifier has been recognized by the image recognition unit for a predetermined period.

3. The display system according to claim 1, wherein the server includes a second storage unit in which the image data of the virtual object that is set corresponding to the identifier is stored, and a second extraction unit that extracts, from the second storage unit, the image data of the virtual object that is provided to the display device, based on the identifier recognized by the image recognition unit.

4. The display system according to claim 3, wherein the first extraction unit extracts, from the first storage unit, the image data of the virtual object based on a list of the image data of the virtual object that is stored in the first storage unit and that is prohibited from being combined with the image data of a predetermined virtual object that is stored in the second storage unit.

5. A display device comprising:
an imager configured to capture an image of a real world;
an image recognition unit configured to recognize an identifier provided to a product that is portable and included in the image captured by the imager;
a display control unit that generates an augmented reality image in which an image of a virtual object is superimposed on scenery of the real world including the product in response to recognition of the identifier;
a display unit that displays the augmented reality image;
a position information acquisition unit that acquires current position information;
a storage unit in which a plurality of types of image data of the virtual object is stored; and
an extraction unit that extracts, from the storage unit, the image data of the virtual object that is superimposed on scenery of the real world, based on the current position information acquired by the position information acquisition unit.

6. A program that causes a computer to function as:
an imager configured to capture an image of a real world;
an image recognition unit configured to recognize an identifier provided to a product that is portable and included in the image captured by the imager;
a display control unit that generates an augmented reality image in which an image of a virtual object is superimposed on scenery of the real world including the product in response to recognition of the identifier;
a display unit that displays the augmented reality image;
a position information acquisition unit that acquires current position information;
a storage unit in which a plurality of types of image data of the virtual object is stored; and
an extraction unit that extracts, from the storage unit, the image data of the virtual object that is superimposed on scenery of the real world, based on the current position information acquired by the position information acquisition unit.
